(19) United States
(12) Patent Application Publication
(10) Pub. No.: US 2025/0020178 A1
(43) Pub. Date: Jan. 16, 2025

(54) CALIPER AND SUPPORT ASSEMBLY, AND METHOD

(71) Applicant: BREMBO S.p.A., Curno (Bergamo) (IT)

(72) Inventors: Daniele PENATI, Curno (Bergamo) (IT); Carlo CANTONI, Curno (Bergamo) (IT); Andrea ODONI, Curno (Bergamo) (IT)

(73) Assignee: BREMBO S.p.A., Curno (Bergamo) (IT)

(21) Appl. No.: 18/715,166

(22) PCT Filed: Nov. 29, 2022
(86) PCT No.: PCT/IB2022/061527

§ 371 Date: May 31, 2024

(30) Foreign Application Priority Data
Dec. 3, 2021 (IT) 102021000030617

(51) Int. Cl. F16D 55/228; F16D 55/00; F16D 66/00

(52) U.S. Cl. CPC F16D 55/228; F16D 66/00; F16D 2055/0012; F16D 2055/0016; F16D 2066/005

(57) ABSTRACT

A caliper and support assembly has a brake caliper having a caliper body, and a supporting structure connected to the caliper body and having a first fixing portion and a second fixing portion for connecting with a vehicle, and a connecting portion for connecting the caliper body to the first fixing portion along a direction parallel to an axial direction or a direction parallel to a radial direction. The connecting portion allows a free movement of the caliper body relative to the supporting structure along a predetermined direction incident to the axial and radial directions or to directions parallel thereto. A constraining element connects the caliper body to the second fixing portion preventing the free movement of the caliper body and during a braking action elastically deforms determining a displacement of the caliper body relative to the supporting structure. A detecting device detects the displacement of the caliper body.

### FIELD OF THE INVENTION

The present invention relates to a caliper and support assembly for a disc brake.

In particular, the present invention relates to a caliper and support assembly comprising a detecting device.

The present invention also relates to a detecting method.

### BACKGROUND ART

In a disc brake, the brake caliper is generally arranged straddling the outer peripheral rim of a brake disc, adapted to rotate about a rotational axis. Brake calipers are constrained to a supporting structure, which remains stationary relative to the vehicle wheel, such as, for example, a stub axle of a vehicle suspension, a vehicle wheel hub, or a fork or yoke of a motorcycle. The brake caliper comprises a caliper body having two elongated portions arranged so as to face opposite braking surfaces of a brake disc, and at least one bridge connecting said two elongated portions to each other.

Brake pads generally comprise a plate onto which a friction material is fixed, adapted to press against a facing braking surface of the braking band of the brake disc. In brake calipers for applications in the field of racing, brake pads are used, in which the plate is made in one piece with the friction material. The plate can comprise auditory wear indicators, sometimes embedded in the friction material, having the function of emitting a sound, by rubbing against the brake band of the disc when the friction material has thinned axially due to prolonged use.

In floating caliper bodies associated with fixed discs, a floating or sliding portion of the caliper body has a cylinder or cylinders adapted to accommodate thrust means capable of applying a thrust action on the clutch pads facing it, abutting it against the braking surface of the disc, while it slides on the bracket, or fixed portion of the caliper, and acts on the second clutch pad abutting it against the brake disc to apply the braking action.

In caliper bodies associated with fixed discs, a cylinder or cylinders is or are present on both opposite sides of the caliper body, adapted to accommodate thrust means capable of applying a thrust action on the clutch pads facing it, abutting it against the braking surface of the disc.

Otherwise, fixed caliper bodies associated with floating discs are also known, where only one of the elongated portions of the caliper body has a cylinder or cylinders adapted to accommodate the thrust means capable of applying a thrust action on the facing clutch pad, abutting it against the braking surface of the disc, which in turn slides axially on its support and abuts against the opposite clutch pad to apply the braking action.

In hydraulically actuated braking systems, the pressure applied by the vehicle driver on the brake pedal applies, through a brake master cylinder, a brake fluid pressure, which through a pipe is applied to the brake fluid present in the hydraulic circuit placed inside the caliper body to reach the cylinders where the pressure is applied onto the bottom surface of the pistons, thus forcing them to close against the pads, which in turn abut against the braking surfaces of the disc.

The pressure action of the brake fluid is also applied to the bottom wall of the cylinder, thus causing a reaction in the caliper body which deforms it away from the disc surfaces. This phenomenon is known as elastic deformation or “strain” of the caliper, which by moving away from the brake disc forces a further bias of the thrust means on the pad to apply the desired braking action.

When the braking action ceases, and thus when the bias which deforms the caliper body away from the brake disc ceases, the caliper body returns to its undeformed resting configuration, approaching the brake disc again, and thus approaching the pads to the braking surfaces. This approaching of the pads to the brake disc is undesired because it results in a contact, albeit minor, between pad and disc, which causes a continuous minor friction and thus a braking action, also known as residual braking torque, even when the braking command by the vehicle driver ceases.

This residual braking torque is often considered undesired because it generates noise, albeit minor, caused by the friction action between pads and disc braking surfaces, undesired wear of the pads and the brake disc, which implies a more frequent maintenance for their replacement, and a minimum fuel consumption for feeding the drive unit with the energy, even if minimum, needed to overcome this residual torque.

During the braking action, the clutch pads closed against the braking band of the disc undergo, due to the rotation of the disc, a drag acceleration by friction directed in tangential or circumferential direction up to abut against tangential abutment portions of the caliper body, such as, for example, pins supporting the pad or projecting walls provided in the caliper body.

Such a dragging action is transferred onto the caliper body and tends to cause an elastic elongation deformation in a tangential direction of the caliper body, and particularly of the caliper body portion present between the elements for constraining the caliper body to the supporting structure fixed to the vehicle. This tangential elongation deformation is typically contrasted by providing elements for constraining the caliper body to the supporting structure, e.g., fixing pins or bushes usually placed at transversely opposite sides of the clutch pad, and thus usually generates tangential jamming or “buckling” phenomena of the caliper body, which generate elastic instability and cause the onset of flexural and torsional stresses on the caliper body.

Furthermore, because of the constraints between the caliper and its supports usually placed only on the caliper side of the hub-side elongated element, a further cutting and torsional deformation can occur, which causes the elongated element not constrained to the support, or wheel-side elongated element, to move relative to the hub-side elongated element, thus flexing the caliper bridges which connect these elongated elements to one another.

Otherwise, in braking systems of the brake-by-wire type, particularly for high-performance vehicles, in which the brake pedal is not connected by means of a hydraulic circuit to the caliper thrust means, a detecting system associated with a data processing unit is present to measure the action applied by the vehicle driver onto the brake pedal and to calculate the corresponding power to be transmitted to the brake caliper thrust means to abut the pads against the opposite braking surfaces of the disc. For the vehicle driver, the braking feeling with brake-by-wire systems changes radically as compared to that of hydraulically actuated brakes, especially as for the mechanical feedback provided by the brake pedal, thus resulting in lower sensitivity for the driver, which can result in poor braking control.

The need to quantify the braking action is therefore strongly felt.

Some solutions for quantifying the braking action in floating calipers based on the indirect measurement of the braking torque have been suggested, i.e., based on detecting quantities associated with the braking torque entity, typically the flexural deformation of the portions of the brake caliper or its support.

For example, document DE-102012007118 shows a sensor system adapted to detect the flexural deformation of dedicated cantilevered connection bridges for connecting the caliper body of a floating caliper to the supporting structure. For example, document U.S. Pat. No. 6,511,135 shows a solution adapted to detect the flexural deformation of the arm of the supporting bracket to the floating caliper placed on the side of the caliper body which sees the disc outlet or the disc outlet side and on which the braking action is released.

These solutions, although being advantageous from some points of view, are applied only to floating calipers and can be complicated to construct, e.g., by requiring the provision of dedicated mechanical devices protruding in a cantilevered manner from the caliper body adapted to be flexurally deformed. It should also be noted that the measurement of a non-linear quantity, such as for example the flexural deformation of a caliper body portion placed so as to be cantilevered, used in such solutions as the basis for calculating the braking torque, imposes a substantial uncertainty in the quantification of the braking action.

From document U.S. Pat. No. 8,146,715 it is known to make, by means of laser cutting, an incision in the body of the floating caliper to construct a cantilever shelf excluded from the flow of the forces generated during the braking action. Proximity sensors are used to measure the change in the width in the axial direction of such an incision during braking. In addition, document US-2012-0198926 shows a device for detecting displacements in an axial direction between a bracket on which the clutch pads are mounted and an elongated portion of the floating caliper body.

Such solutions do not solve the problem and the measurement of the axial deformation of the brake caliper is not adapted to provide a reliable estimate of the braking action, because the axial deformation is correlated in a non-proportional manner to the braking torque, due to the unknown and variable friction depending on the wear condition of the friction material, the operating conditions, such as the temperature of the disc, and environmental conditions, such as rain, for example.

The need is therefore felt to quantify the braking action on the brake calipers of both the floating type and the fixed type in a repeatable and reliable manner.

From document WO2019008534, to the same Applicant, a caliper and support assembly is known, comprising a caliper body connected to a supporting structure, where at least one disc inlet-side fixing device is provided, which constrains the caliper body relative to the supporting structure along the tangential direction by locally preventing the deformation of the disc inlet side of the caliper body relative to the supporting structure along said predetermined direction T-T. This solution further includes a disc outlet-side fixing device which couples to the disc outlet side of the caliper body, avoiding the formation of a constraint in said at least one predetermined direction T-T. With this double constraint system, the deformation of the caliper body is promoted in the tangential direction, and it is possible to quantify the braking action by virtue of a device for measuring the distance between the disc outlet-side fixing device and a slot in the caliper body which accommodates it. This solution, although satisfactory in many respects, is hardly employable in situations in which the braking action induces small tangential deformations of the caliper body, not allowing the deformation measurement to be correlated with the braking action with sufficient accuracy.

Therefore, the need is felt to repeatably and reliably quantify the braking action even when the deformations of the caliper body are extremely small, or even irrespective of the measurement of the caliper body deformation.

Document EP1646853 describes a device mounted centered on the hub of a wheel independently of the brake caliper for measuring forces and moments exchanged on the ground. This solution allows estimating the forces exchanged with the ground by the wheel, thus releasing the quantification of the braking action from the measurement of the caliper body deformation. This solution is very useful when testing a vehicle, but it is highly invasive and unsuitable to be implemented in a race.

The need is strongly felt to measure the braking action in a simple yet repeatable and reliable manner, as well as implementable with little impact on standard brake caliper configurations.

### Solution

It is an object of the present invention to obviate the drawbacks of the prior art and to provide a solution to the needs mentioned above.

These and other objects are achieved by an assembly according to claim 1 as well as by a method according to claim 11.

Some advantageous embodiments are the subject of the dependent claims.

By virtue of the suggested solutions, it is possible to connect a caliper body to a supporting structure by means of a fixed connecting portion so as to allow the displacement of the caliper body during the braking action, and it is possible to constrain the caliper body to the supporting structure by means of a constraining element which is adapted to deform elastically at least along the predetermined direction during a braking action allowing the displacement of the caliper body relative to the supporting structure. Due to the provision of the caliper body being movable along the predetermined direction relative to the supporting structure and constrained relative to the predetermined direction by means of a deformable constraining element, and of a detecting device, it is possible to detect the displacement of the caliper body relative to the supporting structure either directly or indirectly.

According to an aspect of the invention, it is possible to directly detect the displacement of the caliper body relative to the supporting structure in a direct manner by measuring a distance between a portion of the caliper body, which caliper body is movable relative to the supporting structure, facing a portion of the supporting structure.

According to an aspect of the invention, it is possible to detect indirectly the displacement of the caliper body by measuring a change in the length of the constraining element due to its deformation preferably under traction, but deformations under compression, during the braking action, are not excluded.

According to an aspect of the invention, the caliper body is connected to a connecting portion of the supporting structure with a predetermined clearance along the predetermined direction, which allows a displacement of the caliper body within the length of the predetermined clearance. The displacement of the caliper body relative to the connecting portion is allowed only during the braking action because the caliper body is constrained to the supporting structure by the elastically deformable constraining element, which prevents the displacement of the caliper body in the absence of the braking action and allows such a displacement during the braking action by virtue of its elastic deformation.

According to an aspect of the invention, the caliper body comprises a caliper body which delimits a seat wall, connecting seat passing through at least one portion of the caliper body and which accommodates the connecting portion, where the connecting portion is housed in the connecting seat with a predetermined clearance along a predetermined direction so as to prevent the caliper body from abutting against the connecting portion for displacements less than the predetermined clearance.

According to an aspect of the invention, the connecting portion slides with low friction on at least one portion of the connecting seat of the caliper body.

Advantageously, by virtue of the suggested solutions, discharging the braking force along a predetermined direction onto the connecting portion of the supporting structure is avoided, by virtue of the displacement allowed to the caliper body by the deformation of the constraining element along the predetermined direction onto which the braking force along the predetermined direction is discharged.

### FIGURES

Further features and advantages of the assembly and method will become apparent from the following description of preferred embodiments thereof, given by way of non-limiting examples, with reference to the accompanying drawings, in which:

FIG. 1 illustrates an axonometric view of a caliper and supporting structure assembly, according to an embodiment, where a caliper body straddles a brake disc defining a radial direction, an axial direction, and a tangential direction, where the caliper body is connected to an arm of a vehicle suspension, where a connecting portion connects the caliper body to the vehicle along a radial direction so as to allow a displacement of the caliper body along a predetermined direction, and where a constraining element connects the caliper body to the vehicle at least along the predetermined direction so as to prevent the displacement of the caliper body in the absence of a braking action;

FIG. 2 illustrates an exploded axonometric view of the assembly in FIG. 1;

FIG. 3 illustrates an axonometric view of the caliper and supporting structure assembly in FIG. 1, where the caliper body and the supporting structure are partially sectioned along a plane perpendicular to the axial direction,

FIG. 4 illustrates a front view perpendicular to the axial direction of the caliper and supporting structure assembly in FIG. 3, where a first connecting device and a second connecting device connect the caliper body to a first fixing portion, where the caliper body is connected to the connecting portion with a predetermined clearance along the predetermined direction, preventing the caliper body from abutting against the connecting portion during the braking action, thus discharging the braking force onto the constraining element which elastically deforms along the predetermined direction;

FIG. 5 illustrates a detail of the sectioned assembly in FIG. 4, where a first connecting device housed in a first slot of the caliper body is shown, where the predetermined clearance between the first connecting device and the inner wall of a first guide bushing integral with the caliper body is visible;

FIG. 6 illustrates a detail of the assembly in FIG. 4, where a second connecting device housed in a second slot of the caliper body is shown, where the predetermined clearance between the second connecting device and the inner wall of a second guide bushing integral with the caliper body is visible, as well as a spacing between a surface of the caliper body facing a surface of the first fixing portion to which the connecting portion is constrained is visible;

FIG. 7 illustrates a partially sectioned view of the caliper and supporting structure assembly in FIG. 1 taken along a plane perpendicular to the radial direction along which the first and second connecting devices extend, in which it is possible to see the elongated shape along the predetermined direction of the inner surfaces of the first caliper body bushing and the second caliper body bushing, respectively, in particular due to the provision of a a straight flat stretch between two cylindrical semicircular stretches;

FIG. 8 illustrates an axonometric view of a caliper and supporting structure assembly according to an embodiment, where a connecting portion connects the caliper body to the vehicle along an axial direction so as to allow a displacement of the caliper body along a predetermined direction, and a deformable constraining element constrains the caliper body to the vehicle at least along the predetermined direction, preventing the displacement of the caliper body in the absence of the braking action;

FIG. 9 illustrates an exploded axonometric view of the assembly in FIG. 8

FIG. 10 illustrates a plan view perpendicular to the radial direction of the caliper and supporting structure assembly in FIG. 8, where the caliper body, the supporting structure, and the constraining element are partially sectioned according to a plane perpendicular to the radial direction, where a first connecting device and a second connecting device of the connecting portion connect the caliper body to a first fixing portion, where the caliper body is connected to the connecting portion with a predetermined clearance along the predetermined direction, preventing the caliper body from abutting against the connecting portion during the braking action, thus discharging the braking force onto the constraining element which elastically deforms along the predetermined direction;

FIG. 11 and FIG. 12 illustrate an axonometric view of a caliper and supporting structure assembly, according to the variant in FIG. 1 and the variant in FIG. 8, respectively, where the caliper body is connected to a first fixing portion by means of the connecting portion, and where the caliper body is connected to a second fixing portion by means of the deformable constraining element, where the first fixing portion and the second fixing portion are integrated into the same element adapted to be connected to a wheel hub;

FIG. 13 illustrates a section view of one of the two connecting devices of the supporting structure, coupled to the respective first guide bushing or second guide bushing of the brake caliper which internally delimit, at least partially, either a first slot or a second slot, where the clearance between the connecting device and the first wall of the first slot or second slot is shown, as well as the straight stretches of the first wall of the first slot or said second slot, along which the respective connecting device slides with low friction along the predetermined direction of the displacement of the caliper body relative to the supporting structure.

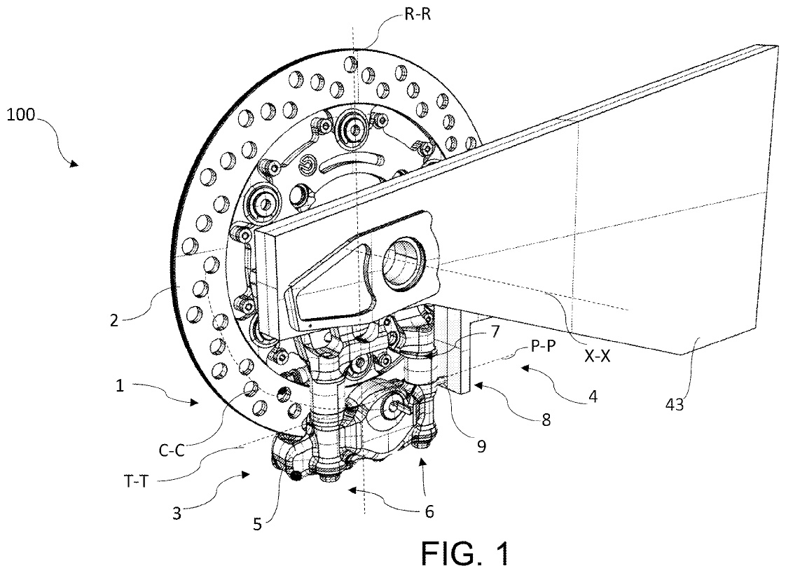

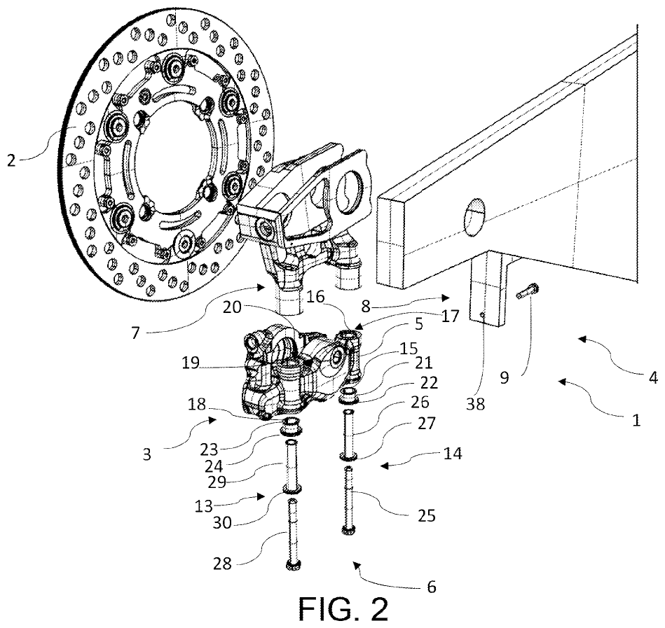

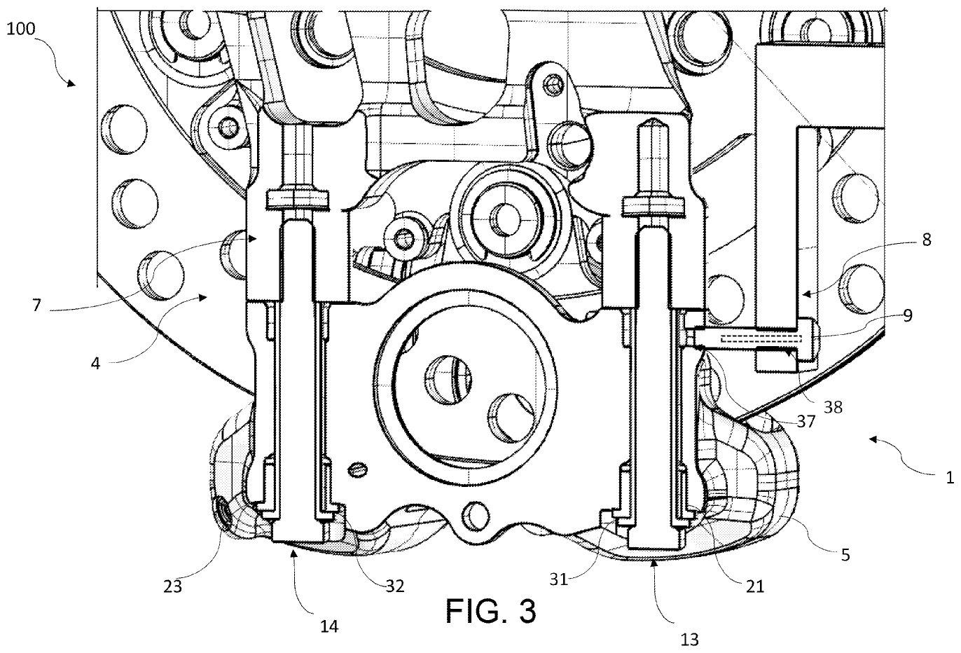

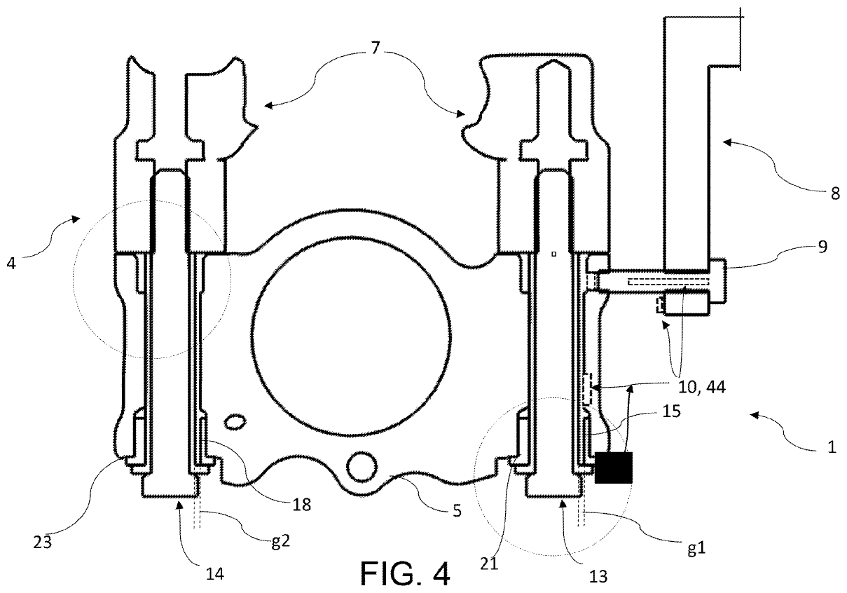

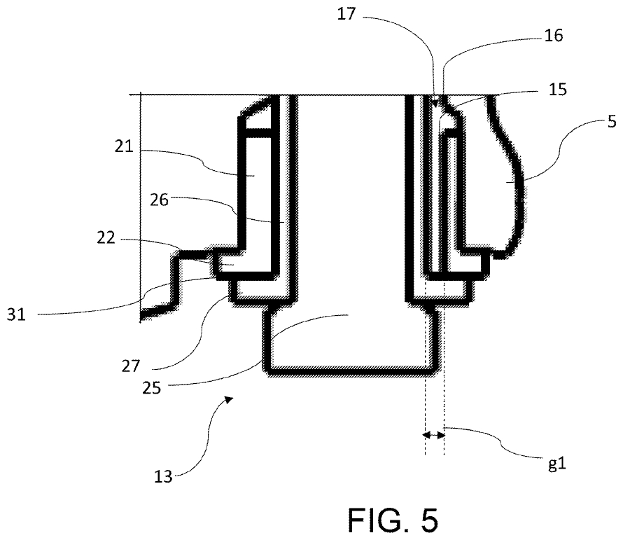

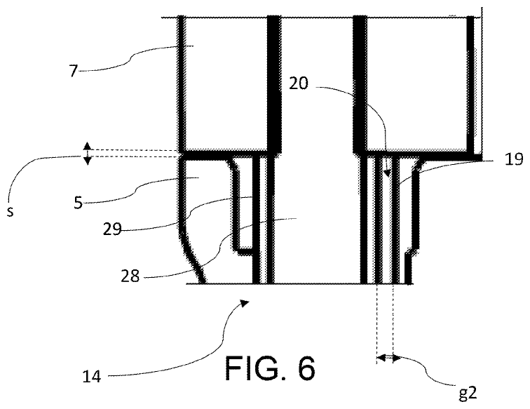

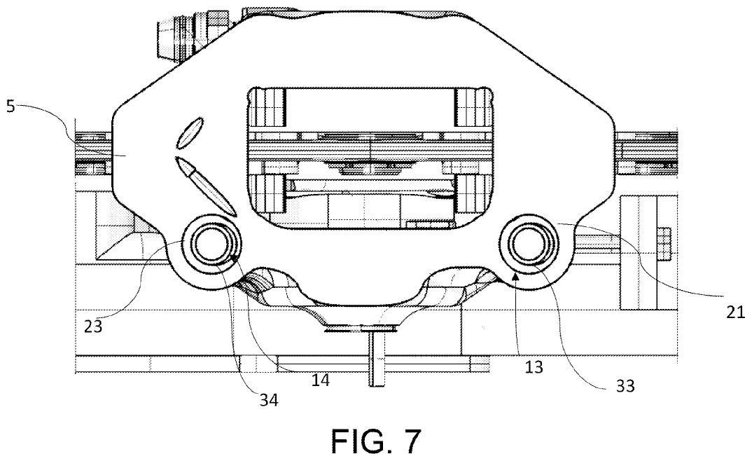

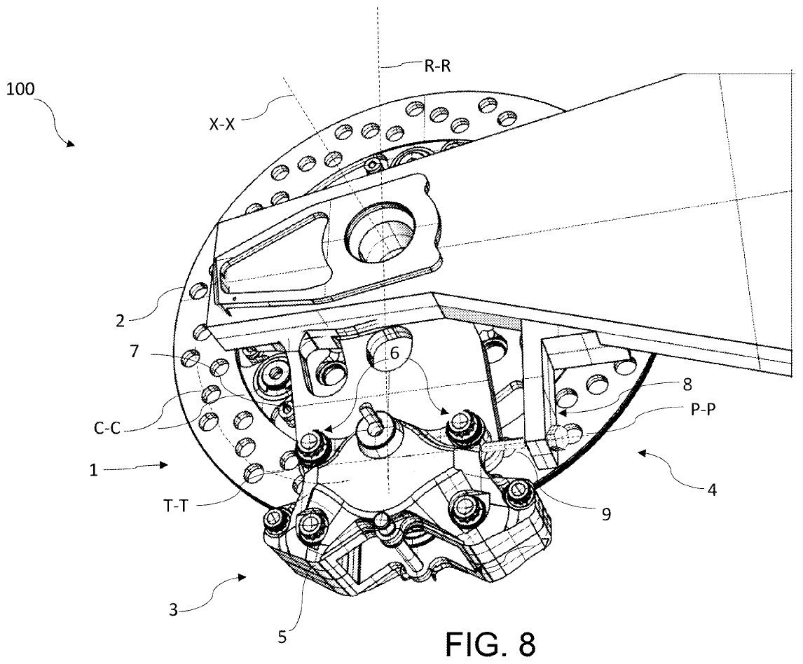

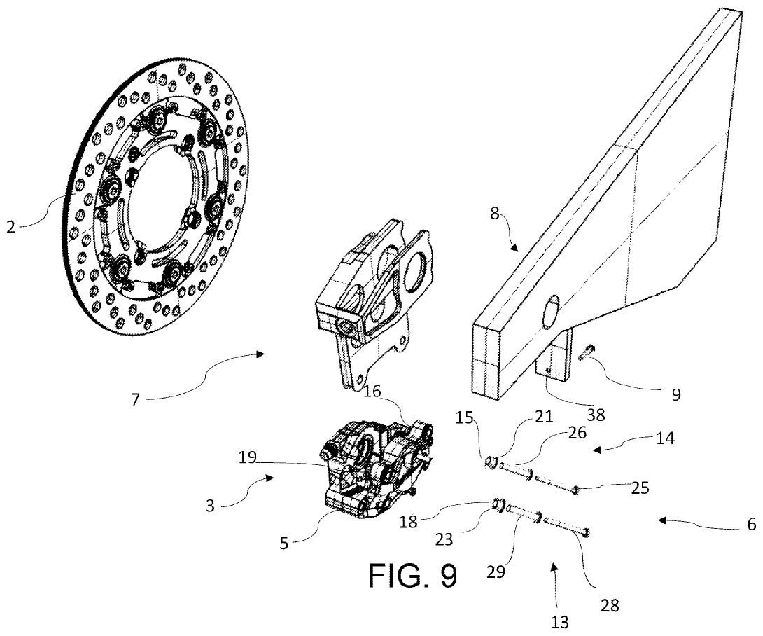

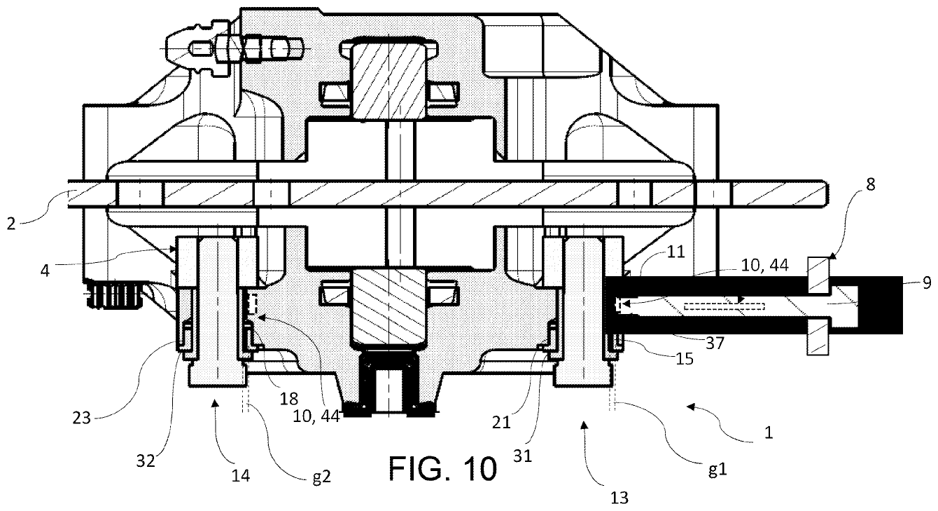

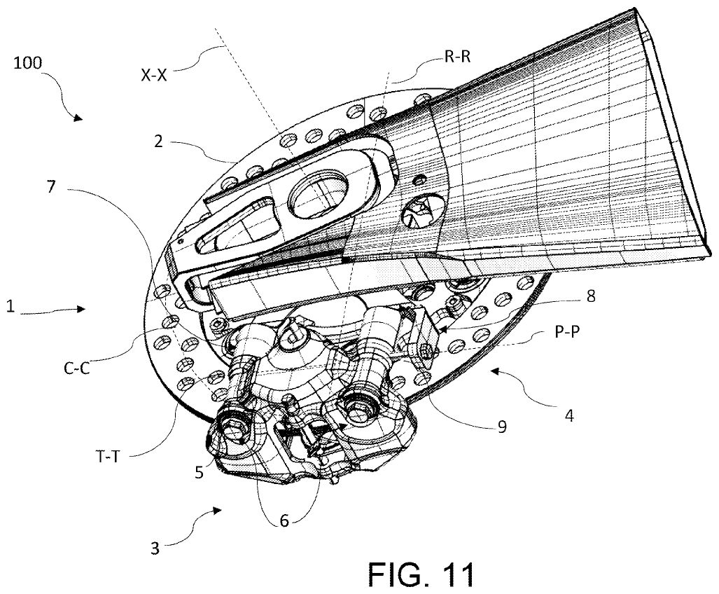

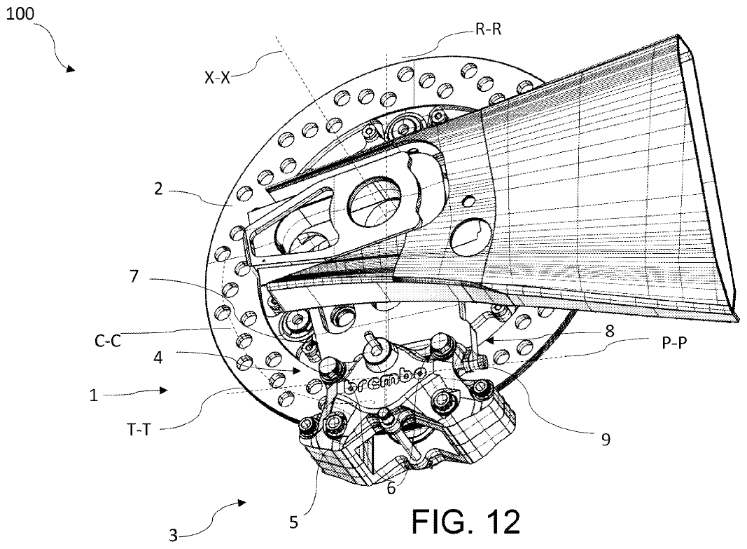

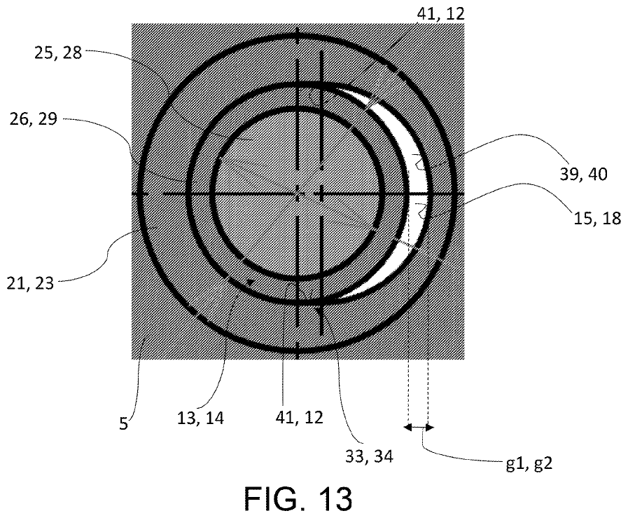

### DESCRIPTION OF SOME PREFERRED EMBODIMENTS

According to a general embodiment, a caliper and support assembly 1 for a disc brake 100 comprises a brake caliper 3 and a supporting structure 4.

An axial direction X-X, either coinciding with or parallel to the rotation axis of a disc 2 of the disc brake 100, a radial direction R-R, orthogonal to the axial direction X-X, a circumferential direction C-C, orthogonal to both the axial direction X-X and the radial direction R-R, and a tangential direction T-T, accurately orthogonal both to the axial direction X-X and to the radial direction R-R are defined in said disc brake 100.

Said brake caliper 3 comprises a caliper body 5, adapted to straddle an associable disc 2 of the disc brake 100.

Said supporting structure 4 is connected to said caliper body 5.

Said supporting structure 4 comprises a first fixing portion 7 and a second fixing portion 8 adapted to connect integrally to a vehicle, e.g., a vehicle suspension arm.

Advantageously, said supporting structure 4 comprises a connecting portion 6 adapted to connect the caliper body 5 to the first fixing portion 7 at least along a direction parallel to said axial direction X-X or along a direction parallel to said radial direction R-R, allowing a displacement of the caliper body 5 relative to said supporting structure 4 along a predetermined direction P-P, where said predetermined direction P-P is incident to said axial direction X-X and to said radial direction R-R or to directions parallel thereto.

Said caliper and support assembly 1 comprises a constraining element 9 configured to connect the caliper body 5 to the second fixing portion 8 along said predetermined direction P-P preventing said displacement of the caliper body 5 in the absence of a braking action.

During the braking action, said constraining element 9 elastically deforms according to at least said predetermined direction P-P, resulting in said displacement of the caliper body 5 relative to the supporting structure 4 in at least said predetermined direction P-P.

Said caliper and support assembly 1 comprises at least one detecting device 10, which either directly or indirectly detects the displacement of said caliper body 5 relative to the supporting structure 4 along at least said predetermined direction P-P.

According to an embodiment, said at least one predetermined direction P-P is the tangential direction T-T.

Due to the provision of said detecting device 10, it is possible to detect said distance d, which is proportional to the braking action. Thereby, it is possible to calculate the braking torque based on information acquired by said detecting device 10.

Due to the provision of said detecting device 10, it is possible to detect the elastic deformation under traction or under compression of the constraining element 9, which is proportional to the braking action. Thereby, it is possible to calculate the braking torque based on information acquired by said detecting device 10.

Due to the provision of such a detecting device 10, the distance d evaluated in the tangential direction T-T is proportional to the force with which the disc pushes the pads in the tangential direction T-T. Thereby, it is possible to quantify the braking action by evaluating the deformation in the tangential direction T-T of at least one constraining element 9.

According to an embodiment, the at least one detecting device 10 directly detects said displacement of said caliper body 5 by detecting a distance d along at least said predetermined direction P-P between a caliper body portion and a supporting structure portion 6, 7, 8 facing the caliper body portion. Said supporting structure portion 6, 7, 8 being one of said first fixing portion 7, said second fixing portion 8, and said connecting portion 6. According to an embodiment, said caliper body portion faces said supporting structure portion 6, 7, 8 along said predetermined direction P-P.

According to an embodiment, said at least one detecting device 10 indirectly detects said displacement of said caliper body 5 by detecting at least one elongation 1 of said constraining element 9 along at least said predetermined direction P-P due to the elastic deformation of said constraining element 9 during the braking action.

According to an embodiment, said at least one detecting device 10 comprises at least one sensor 44.

According to an embodiment, said connecting portion 6 comprises a first connecting device 13 which mainly extends along said radial direction R-R or said axial direction X-X, depending on the type of connection between the caliper body and the supporting structure.

According to an embodiment, said connecting portion 6 comprises a second connecting device 14 which mainly extends along said radial direction R-R or said axial direction X-X.

According to an embodiment, said first connecting device 13 and said second connecting device 14 are constrained to said first fixing portion 7.

According to an embodiment, said brake caliper 3 comprises at least a first guide bushing 21 integrally connected to said caliper body 5, where said first guide bushing 21 comprises a first slot first wall 15 which at least partially delimits a first slot 17. Said first slot 17 receives said first connecting device 20 with a first predetermined clearance g1 at least along said predetermined direction P-P.

According to an embodiment, said brake caliper 3 comprises at least a second guide bushing 23 integrally connected to said caliper body 5, where said second guide bushing 23 comprises a second slot first wall 18, which at least partially delimits a second slot 20. Said second slot 20 receives said second connecting device 14 with a second predetermined clearance g2 at least along said predetermined direction P-P.

According to an embodiment, said first slot 17 receives said first connecting device 20 with a first predetermined clearance g1 at least along said predetermined direction P-P, and said second slot 20 receives said second connecting device 14 with a second predetermined clearance g2 at least along said predetermined direction P-P so as to allow said displacement of the caliper body 5 along said predetermined direction P-P relative to the supporting structure 4.

According to an embodiment, said first connecting device 13 and said first slot 17 couple avoiding the formation of a constraint along said at least one predetermined direction P-P between said caliper body 5 and said supporting structure 4.

According to an embodiment, said second connecting device 14 and said second slot 20 couple avoiding the formation of a constraint along said at least one predetermined direction P-P between said caliper body 5 and said supporting structure 4.

According to an embodiment, said first connecting device 13 cooperates with said first slot wall 15 forming a constraint in the axial direction X-X or radial direction R-R between said caliper body 5 and said supporting structure 4.

According to an embodiment, said second connecting device 14 cooperates with said second slot first wall 18 forming a constraint in the axial direction X-X or radial direction R-R between said caliper body 5 and said supporting structure 4.

According to an embodiment, said caliper body 5 comprises at least one seat wall 12 at least partially delimiting a constraint seat 37, and where said constraint seat 37 receives an end portion of said constraining element 9.

According to an embodiment, said second fixing portion 8 comprises a fixing bracket comprising a constraining slot 38 passing through the thickness of said fixing bracket, where said constraining element 9 is accommodated in said constraining slot 38 and where a head of said constraining element 9 abuts against an outer wall of said fixing bracket.

According to an embodiment, said constraining element 9 cooperates with said at least one seat wall 11 and said at least one constraining slot 38 by constraining said caliper body 5 to said supporting structure 4 along said predetermined direction P-P and forming a constraint in the axial direction X-X and/or radial direction R-R between said caliper body 5 and said supporting structure 4.

According to an embodiment, said constraining element 9 is designed and sized such that its maximum elongation lmax along at least said predetermined direction P-P during the braking action is less than said first predetermined clearance t1 and/or said second predetermined clearance t2.

According to an embodiment, said first predetermined clearance t1 is equal to said second predetermined clearance t2. According to an embodiment, the maximum elongation lmax of the constraining element 9 is designed and sized so as to prevent said first connecting device 13 and/or said second connecting device 14 from abutting against said first slot first wall 15 and/or said second slot first wall 18 when said caliper body 5 moves along said predetermined direction P-P.

According to an embodiment, said caliper body 5 comprises a first slot second wall 16 delimiting said first slot 17 downstream of said first slot first wall 15 in the direction of said first fixing portion 7. According to an embodiment, said first slot second wall is cylindrical and avoids coming into contact with the first connecting device.

According to an embodiment, said caliper body 5 comprises a second slot second wall 19 delimiting said second slot wall 20 downstream of said second slot first wall 18 in the direction of said first fixing portion 7. According to an embodiment, said second slot second wall is cylindrical and avoids coming into contact with the second connecting device.

According to an embodiment, said first guide bushing 21 and said first connecting device 13 comprise respective first sliding surfaces 31 and respective second sliding surfaces 33 to allow a low-friction sliding of the caliper body 5 relative to the supporting structure 4 along said predetermined direction P-P during the braking action, where said first sliding surfaces 31 and said second sliding surfaces 33 are mutually transverse.

According to an embodiment, said second guide bushing 23 and said second connecting device 14 comprise respective third sliding surfaces 32 and respective fourth sliding surfaces 34 to allow a low-friction sliding of the caliper body 5 relative to the supporting structure 4 along said predetermined direction P-P during the braking action, where said third sliding surfaces 32 and said fourth sliding surfaces 34 are mutually transverse.

According to an embodiment, said first slot first wall 15 describes a first slot edge profile 39 of elongated shape along said predetermined direction P-P, avoiding the formation of a constraint between said caliper body 5 and said first connecting device 13 in said predetermined direction P-P during the displacement of said caliper body 5.

According to an embodiment, said second slot first wall 18 describes a second slot edge profile of elongated shape along said predetermined direction P-P, avoiding the formation of a constraint between said caliper body 5 and said second connecting device 14 in said predetermined direction P-P during the displacement of said caliper body 5.

According to an embodiment, said first slot first wall 18 comprises at least a first slot straight stretch 41, where said at least a first slot straight stretch 41 lies on a first plane and has a first length along said predetermined direction P-P at least equal to said first predetermined clearance g1. According to an embodiment, said first plane is parallel to said predetermined direction P-P and is transverse to said radial direction R-R or said axial direction X-X. Said first connecting devices 13 slides on said first slot straight stretch 41. According to an embodiment, said first sliding surfaces 31 comprise said at least a first slot straight stretch 41 and an outer surface portion of said first connecting device 13 facing said straight stretch. Preferably, the outer surface portion of said first connecting device is cylindrical, forming a contact surface reduced to a straight stretch.

According to an embodiment, said second slot first wall 18 comprises at least a second slot straight stretch 12, where said at least a second slot straight stretch 12 lies on a second plane and has a second length along said predetermined direction P-P at least equal to said second predetermined clearance g2. According to an embodiment, said second plane is parallel to said predetermined direction P-P and is transverse to said radial direction R-R or said axial direction X-X. Said second connecting device 14 slides on said second slot straight stretch 12. According to an embodiment, said surfaces 32 third sliding comprise said at least a second slot straight stretch 12 and an outer surface portion of said second connecting device 14 facing said straight stretch. Preferably, the outer surface portion of said second connecting device is cylindrical, forming a contact surface reduced to a straight stretch.

According to an embodiment, said first guide bushing 21 comprises a first guide flange 22. According to an embodiment, said second guide bushing 23 comprises a second guide flange 24. According to an embodiment, said first guide flange 22 and said second guide flange 24 lie on a guide plane, where said guide plane is parallel to said predetermined direction P-P and is parallel to either said axial direction X-X or said radial direction R-R. According to an embodiment, said first connecting device 13 and said second connecting device 14 slide on said guide plane, on said first guide flange 22 and said second guide flange 24, respectively. According to an embodiment, said first connecting device 13 comprises a first bushing flange 27. According to an embodiment, said second connecting device 14 comprises a second bushing flange 30. According to an embodiment, said first bushing flange 27 and said second bushing flange 30 slide on said first guide flange 22 and said second guide flange 24, respectively. According to an embodiment, said second sliding surfaces 33 comprise at least partially said first guide flange 22 and said first bushing flange 27. According to an embodiment, said fourth sliding surfaces 34 comprise at least partially said second bushing flange 30 and said second guide flange 24.

According to an embodiment, said first connecting device 13 comprises a first pin 25 and at least a first bushing 26 fitted onto said first pin 25.

According to an embodiment, said second connecting device 14 comprises a second pin 28 and at least a second bushing 29 fitted onto said second pin 28.

According to an embodiment, said constraining element 9 comprises a screw.

According to an embodiment, said first connecting device 13 and said second connecting device 14 each comprise a stud.

According to an embodiment, said first guide bushing 21 is made in one piece with said caliper body 5.

According to an embodiment, or where said first guide bushing 21 is housed in a first guide bushing seat 35 made in the caliper body 5, where said first guide bushing 21 comprises an inner wall comprising said first slot wall 15, and an outer wall coupled by shape or by interference to a seat wall defining said first guide bushing seat 35.

According to an embodiment, said second guide bushing 23 is made in one piece with said caliper body 5.

According to an embodiment, said second guide bushing 23 is housed in a second guide bushing seat 36 made in the caliper body, where said second guide bushing 23 comprises an inner wall comprising said second slot first wall 18, and an outer wall coupled by shape or by interference to a seat wall defining said second guide bushing seat 36.

According to an embodiment, said first bushing device 26 comprises a first bushing flange 27.

According to an embodiment, said second bushing 29 comprises said second bushing flange 30.

According to an embodiment, said first guide flange 22 is in sliding abutment with said first bushing flange 27, where said second guide flange 24 is in sliding abutment with said second bushing flange 30.

According to an embodiment, said caliper body rests on said first bushing flange 27 and said second bushing flange 30, by means of said first guide flange 22 and said second guide flange 24.

According to an embodiment, said first fixing portion 7 comprises a first fixing portion surface facing said caliper body 5. According to an embodiment, said first bushing 26 abuts with a first end thereof opposite to said first bushing flange 27 against said first fixing portion surface. According to an embodiment, said second bushing 29 abuts with a first end thereof opposite to said second bushing flange 30 against said first fixing portion surface.

According to an embodiment, said first bushing 26 and said second bushing 29 have respective longitudinal lengths adapted to avoid a direct contact between said caliper body 5 and the first fixing portion surface while maintaining a spacing s between said caliper body 5 and said first fixing portion 7.

According to an embodiment, said first pin 25 and said second pin 28 are integral with the first bushing 28 the said second bushing 29, respectively, where said first pin 25 and said second pin 28 have a respective pin head abutting against said first bushing flange 27 and said second bushing flange 30.

According to an embodiment, said first pin 25 and said second pin 28 comprise a respective tail portion accommodated and constrained to a respective constraining device seat made in said first fixing portion 7.

According to an embodiment, said first fixing portion 7 and said second fixing portion 8 are directly connected and/or integrated and/or made in one piece.

According to an embodiment, said second fixing portion 8 is made as a separate piece from said first fixing portion 7 and is indirectly connected to said first fixing portion 7, e.g., through a yoke 43, or a fork, of a motorcycle.

According to an embodiment, said supporting structure 4 is connected to an arm of a vehicle suspension.

According to an embodiment, said first fixing portion 7 comprises a portion adapted to receive a wheel pin connectable to a vehicle wheel hub.

According to an embodiment, said first fixing portion 7 comprises a connecting counter-portion adapted to rigidly connect to said connecting portion 6.

According to an embodiment, said second fixing portion 8 comprises a connecting flange, which protrudes, e.g., as an L, from said first fixing portion 7, facing a portion of the caliper body 5.

According to an embodiment, said second fixing portion 8 comprises a connecting flange, which protrudes, from a yoke 43 or a fork, facing a portion of the caliper body 5.

According to an embodiment, said connecting portion 6 has a substantially cylindrical extension about said radial direction R-R or said axial direction X-X forming a radial connection or an axial connection, respectively, between said caliper body 5 and said supporting structure 4.

According to an embodiment, said constraining element 9 comprises said detecting device 10 integrated, where said detecting device 10 detects said at least one elongation 1 of said constraining element 9 along at least said predetermined direction P-P.

According to an embodiment, at least one sensor 44 is integral with the constraining element 9 and/or where said constraining element 9 is an instrumented screw comprising said at least one sensor 44.

According to an embodiment, said at least one sensor 44 is a strain gauge and/or a capacitive and/or ultrasonic strain detecting device. According to an embodiment, said sensor 44 is integral with the caliper body 5, e.g., with said caliper body. According to an embodiment, said sensor 44 is integral with the supporting structure 4, e.g., said supporting structure portion.

According to an embodiment, said caliper body portion or said supporting structure portion comprises said at least one sensor 44 housed therein.

According to an embodiment, said at least one sensor 44 is an eddy current sensor.

According to an embodiment, said at least one sensor 44 is an LVDT.

According to an embodiment, said at least one sensor 44 comprises a cantilevered sensor portion, which protrudes in a cantilevered manner from said first slot first wall 15 into said first slot 17 towards said first connecting device 13 or from said second slot first wall 18 into said second slot 20 towards said second connecting device 14, preferably said cantilevered sensor portion extends substantially along said predetermined direction T-T.

According to an embodiment, said sensor 44 comprises an output portion of the sensor adapted to connect to at least one data transmission wire.

According to an embodiment, said detecting device 10 is associated with a data processing unit adapted to receive information on said distance d or said elongation I to quantify the braking action and/or estimate the braking torque and/or calculate the braking force. Preferably, said detecting device 10 is associated with a data processing unit by means of said data transmission wire.

According to an embodiment, said caliper body 5 or said supporting structure portion comprises a flattened surface made substantially orthogonal to the direction along which the displacement of the caliper body 5 is measured, preferably along said predetermined direction P-P, where said detecting device 10 is placed on said flattened surface so as to face said supporting structure portion or said caliper body 5.

The present invention further relates to a method for detecting a displacement of a caliper body 5 relative to a supporting structure 4 during a braking action.

The method comprises the steps of:
connecting said caliper body 5 to a first fixing portion 7 of the supporting structure 4 with a connecting portion 6 of said supporting structure 4, so as to allow the displacement of the caliper body 5 along a predetermined direction P-P;
constraining said caliper body 5 to a second fixing portion 8 of said supporting structure 4 with a constraining element 9 elastically deformable at least along said predetermined 10 direction P-P to allow the displacement of the caliper body 5 during the braking action and to prevent the displacement of the caliper body 5 in the absence of the braking action;
detecting the displacement of the caliper body 5 during the braking action in a direct or indirect manner.

The step of detecting the displacement in a direct manner includes:
identifying a caliper body portion facing, preferably along the predetermined direction P-P, a supporting structure portion comprising one of said first fixing portion 7, said second fixing portion 8, and said connection portion, and
measuring a distance d between said caliper body portion and said supporting structure portion during the braking action.

The step of detecting the displacement in an indirect manner includes:
measuring a change in the length of said constraining element 9 at least along said predetermined direction P-P.

According to an operation mode, said method includes:
calculating a maximum braking force to be applied by the brake caliper along said predetermined direction P-P on said constraining element 9,
sizing said constraining element 9 so as to support said maximum braking force by elastically deforming with a maximum elastic deformation (lmax), e.g., a maximum elongation,
making a connecting counter-portion, e.g., said first slot 17 and said second slot 20, in said caliper body so as to connect said brake caliper on said connecting portion of the supporting structure, e.g., said first connecting device 13 and said second connecting device 14, with a predetermined clearance, e.g., said first predetermined clearance g1 and said second predetermined clearance g2, along said predetermined direction P-P at least equal to the extension of said maximum elastic deformation.

By virtue of the features described above, it is possible to obtain an assembly, as well as a method, that simultaneously meet the above-described needs and the aforesaid desired advantages, and in particular:
it is possible to detect the displacement of the caliper body in a simple and repeatable manner;
it is possible to detect the deformation of the constraining element 9 in a simple and repeatable manner;
it is possible to obtain a method for quantifying the braking action, based on detecting the deformation of the constraining element and/or the displacement of the caliper body relative to the supporting structure, which is simple to implement while having an improved reliability and repeatability as compared to known solutions, and being adapted for every type of brake caliper;
it is possible to detect a quantity proportional to the braking torque;
it is possible to establish a connection between the caliper body and a first fixing portion of the supporting structure which allows a displacement of the caliper body along a predetermined P-P direction by discharging the braking force onto a deformable constraining element which connects the caliper body to a second fixing portion of the supporting structure.

### LIST OF REFERENCE SIGNS

1 Caliper and support assembly
2 disc
3 brake caliper
4 supporting structure
5 caliper body
6 connecting portion
7 first fixing portion
8 second fixing portion
9 constraining element
10 detecting device
11 constraint seat wall
12 second slot straight stretch
13 first connecting device
14 second connecting device
15 first slot first wall
16 first slot second wall
17 first slot
18 second slot first wall
19 second slot second wall
20 second slot
21 first guide bushing
22 first guide flange
23 second guide bushing
24 second guide flange
25 first pin
26 first bushing
27 first bushing flange
28 second pin
29 second bushing
30 second bushing flange
31 first sliding surfaces
32 third sliding surfaces
33 second sliding surfaces
34 fourth sliding surface
35 first guide bushing seat
36 second guide bushing seat
37 constraint seat
38 constraining slot
39 first slot edge profile
40 second slot edge profile
41 first slot straight stretch
43 yoke
44 sensor
100 Disc brake
g1 first clearance
g2 second clearance
Imax maximum elongation of constraining element
d detected distance between movable caliper and fixed support
l detected elongation of constraining element
s spacing
X-X axial direction
R-R radial direction
C-C circumferential direction
T-T tangential direction
P-P predetermined direction

1-11. (canceled)

12. A caliper and support assembly for a disc brake, wherein an axial direction, either coinciding with or parallel to a rotation axis of a disc of the disc brake, a radial direction, orthogonal to the axial direction, a circumferential direction, orthogonal to both the axial direction and the radial direction, and a tangential direction, orthogonal both to the axial direction and to the radial direction are defined;
said caliper and support assembly comprising a brake caliper comprising a caliper body adapted to straddle an associable disc of the disc brake, and a supporting structure connected to the caliper body, wherein
said supporting structure comprises:
a first fixing portion and a second fixing portion adapted to connect integrally with a vehicle, and
a connecting portion adapted to connect the caliper body to the first fixing portion at least along a direction parallel to said axial direction or along a direction parallel to said radial direction, wherein the connecting portion allows a free movement of the caliper body relative to the supporting structure along a predetermined direction, wherein said predetermined direction is incident to said axial direction and to said radial direction or to directions parallel thereto, wherein
said caliper and support assembly further comprises a constraining element configured to connect the caliper body to the second fixing portion along said predetermined direction preventing the free movement of the caliper body, wherein
during a braking action the constraining element elastically deforms according to at least said predetermined direction, determining a displacement of the caliper body relative to the supporting structure in at least said predetermined direction; and wherein
said caliper and support assembly further comprises at least one detecting device that either directly or indirectly detects the displacement of the caliper body relative to the supporting structure along at least said predetermined direction.

13. The caliper and support assembly of claim 12, wherein said predetermined direction is the tangential direction, and wherein the caliper and support assembly comprises at least one of the following features or a combination thereof:
the at least one detecting device directly detects the displacement of the caliper body by detecting a distance along at least said predetermined direction between a caliper body portion and a supporting structure portion, wherein the caliper body portion faces the supporting structure portion, the supporting structure portion being either the first fixing portion, the second fixing portion or the connecting portion,
the at least one detecting device indirectly detects the displacement of the caliper body by detecting at least one elongation of the constraining element along at least said predetermined direction due to an elastic deformation of the constraining element during the braking action,
the at least one detecting device comprises at least one sensor.

14. The caliper and support assembly of claim 13, wherein the caliper body portion faces the supporting structure portion along the predetermined direction.

15. The caliper and support assembly of claim 13, wherein the connecting portion comprises:
a first connecting device that mainly develops along said radial direction or said axial direction, and
a second connecting device that mainly develops along said radial direction or said axial direction,
wherein the first connecting device and the second connecting device are constrained to the first fixing portion,
wherein said brake caliper further comprises:
at least one first guide bushing integrally connected to the caliper body, wherein the first guide bushing comprises a first slot first wall at least partially delimiting a first slot,
at least one second guide bushing integrally connected to the caliper body, wherein the second guide bushing comprises a second slot first wall at least partially delimiting a second slot, and
wherein the first slot receives the first connecting device with a first predetermined clearance at least along said predetermined direction and the second slot receives the second connecting device with a second predetermined clearance at least along said predetermined direction to allow the displacement of the caliper body along said predetermined direction relative to the supporting structure.

16. The caliper and support assembly of claim 15, wherein the first connecting device and the first slot couple avoiding forming a constraint along said predetermined direction between the caliper body and the supporting structure, and wherein the second connecting device and the second slot couple avoiding forming a constraint along said predetermined direction between the caliper body and the supporting structure.

17. The caliper and support assembly of claim 15, wherein the first connecting device cooperates with the first slot first wall forming a constraint in the axial direction or the radial direction between the caliper body and the supporting structure, and wherein the second connecting device cooperates with the second slot first wall forming a constraint in the axial direction or the radial direction between the caliper body and the supporting structure.

18. The caliper and support assembly of claim 15, wherein the caliper body comprises at least one seat wall that at least partially delimits a constraint seat, wherein the constraint seat receives an end portion of the constraining element, wherein the second fixing portion comprises a fixing bracket comprising a constraining slot passing through a thickness of the fixing bracket, wherein the constraining element is received in the constraining slot, and a head of the constraining element abuts against an outer wall of the fixing bracket, and wherein the constraining element cooperates with the at least one seat wall and with the constraining slot by constraining the caliper body to the supporting structure along said predetermined direction and forming a constraint in the axial direction and/or in the radial direction between the caliper body and the supporting structure.

19. The caliper and support assembly of claim 15, wherein the constraining element is designed and dimensioned so that a maximum elongation thereof along said predetermined direction during the braking action is less than said first predetermined clearance and/or said second predetermined clearance, preventing the first connecting device and/or the second connecting device from abutting against the first slot first wall and/or the second slot first wall when the caliper body is displaced along said predetermined direction.

20. The caliper and support assembly of claim 15, wherein the caliper body comprises a first slot second wall that delimits the first slot downstream of the first slot first wall in direction of the first fixing portion, and wherein the caliper body comprises a second slot second wall that delimits the second slot downstream of the second slot first wall in direction of the first fixing portion.

21. The caliper and support assembly of claim 15, wherein
the first guide bushing and the first connecting device comprise respective first sliding surfaces and respective second sliding surfaces to allow low-friction sliding of the caliper body relative to the supporting structure along said predetermined direction during the braking action, wherein the first sliding surfaces and the second sliding surfaces are mutually transverse, wherein
the second guide bushing and the second connecting device comprise respective third sliding surfaces and respective fourth sliding surfaces to allow low-friction sliding of the caliper body relative to the supporting structure along said predetermined direction during the braking action, wherein the third sliding surfaces and the fourth sliding surfaces are mutually transverse, and wherein the caliper and support assembly comprises at least one of the following features or a combination thereof:
the first slot first wall describes a first slot edge profile of elongated shape along said predetermined direction, avoiding forming a constraint between the caliper body and the first connecting device in said predetermined direction during the displacement of the caliper body, and the second slot first wall describes a second slot edge profile of elongated shape along said predetermined direction, avoiding forming a constraint between the caliper body and the second connecting device in said predetermined direction during the displacement of the caliper body,
the first slot first wall comprises at least one first slot straight stretch, wherein the at least one first slot straight stretch lies on a first plane and has a first length along said predetermined direction at least equal to said first predetermined clearance, wherein the first plane is parallel to said predetermined direction and transverse to said radial direction or to said axial direction, and wherein the first connecting device is sliding on the at least one first slot straight stretch, and the second slot first wall comprises at least one second slot straight stretch, wherein the at least one second slot straight stretch lies on a second plane and has a second length along said predetermined direction at least equal to said second predetermined clearance, wherein the second plane is parallel to said predetermined direction and transverse to said radial direction or to said axial direction, and wherein the second connecting device is sliding on the second slot straight stretch,
the first guide bushing comprises a first guide flange and the second guide bushing comprises a second guide flange, wherein the first guide flange and the second guide flange lie on a guide plane, wherein the guide plane is parallel to said predetermined direction and to said axial direction or to said radial direction, wherein the first connecting device and the second connecting device slide on the guide plane, respectively on the first guide flange and on the second guide flange,
the first connecting device comprises a first bushing flange and the second connecting device comprises a second bushing flange, wherein the first bushing flange and the second bushing flange are respectively slidable on the first guide flange and the second guide flange.

22. The caliper and support assembly of claim 21, wherein
said first connecting device comprises a first pin and at least one first bushing fitted on the first pin, wherein the first pin and the first bushing are mutually integral, and wherein the caliper and support assembly comprises at least one of the following features or a combination thereof:
the second connecting device comprises a second pin and at least one second bushing fitted on the second pin,
the constraining element comprises a screw,
the first connecting device and the second connecting device each comprise a stud,
the first guide bushing is made in one piece with the caliper body or the first guide bushing is housed in a first guide bushing seat made in the caliper body, the first guide bushing comprising:
an inner wall comprising the first slot first wall, and
an outer wall coupled by shape or by interference with a seat wall that defines the first guide bushing seat,
the second guide bushing is made in one piece with the caliper body or the second guide bushing is housed in a second guide bushing seat made in the caliper body, the second guide bushing comprising:
an inner wall comprising the second slot first wall, and
an outer wall coupled by shape or by interference with a seat wall that defines the second guide bushing seat.

23. The caliper and support assembly of claim 22, wherein
the first bushing comprises a first bushing flange, and the second bushing comprises a second bushing flange, wherein the first guide flange slidably abuts against the first bushing flange, and the second guide flange slidably abuts against the second bushing flange,
the first fixing portion comprises a first fixing portion surface facing the caliper body,
the first bushing abuts with a first end thereof opposite the first bushing flange against the first fixing portion surface,
the second bushing abuts with a first end thereof opposite to the second bushing flange with the first fixing portion surface, and wherein
the first bushing and the second bushing have respective longitudinal lengths adapted to avoid a direct contact between the caliper body and the first fixing portion surface while maintaining a distance between the caliper body and the first fixing portion, and/or wherein
the first pin and the second pin are integral with the first bushing and the second bushing, respectively, wherein the first pin and the second pin have a respective pin head abutting against the first bushing flange and the second bushing flange, and the first pin and the second pin comprise a respective tail portion accommodated and constrained to a respective constraining device seat made in the first fixing portion.

24. The caliper and support assembly of claim 12, wherein the first fixing portion and the second fixing portion are directly connected and/or integrated and/or made in one piece, or wherein the second fixing portion is made in a separate piece from the first fixing portion and is indirectly connected to the first fixing portion, optionally the second fixing portion being connected to the first fixing portion through a yoke, and wherein the caliper and support assembly comprises at least one of the following features:
the supporting structure is connected to an arm of a suspension of the vehicle,
the first fixing portion comprises a counter-connecting portion adapted to rigidly connect to the connecting portion,
the second fixing portion comprises a connecting flange that protrudes, optionally as an L, from the first fixing portion or from the yoke, facing a portion of the caliper body,
the connecting portion has main development along said radial direction or along said axial direction respectively forming a radial connection or an axial connection between the caliper body and the supporting structure.

25. The caliper and support assembly of claim 13, wherein the constraining element comprises, integrated, the at least one detecting device, wherein the at least one detecting device detects the at least one elongation of the constraining element along at least said predetermined direction, and wherein the caliper and support assembly comprises at least one of the following features:
the at least one sensor is integral with the constraining element,
the constraining element is an instrumented screw comprising the at least one sensor,
the at least one sensor is a strain gage, and/or a capacitive and/or ultrasonic strain detecting device.

26. The caliper and support assembly of claim 15, wherein the at least one sensor is integral with the caliper body, optionally with the caliper body portion, or with the supporting structure, with the supporting structure portion, and wherein the caliper and support assembly comprises at least one of the following features:
the caliper body portion or the supporting structure portion comprises housed the at least one sensor,
the at least one sensor is an eddy current sensor,
the at least one sensor is a linear variable differential transformer (LVDT) sensor,
the at least one sensor comprises a sensor cantilever portion that protrudes from the first slot first wall into the first slot towards the first connecting device or from the second slot first wall into the second slot towards the second connecting device,
the at least one sensor comprises an output portion adapted to connect with at least a data transmission wire;
the caliper body or the supporting structure portion comprises a flattened surface substantially orthogonal to a direction along which the displacement of the caliper body is measured, preferably along said predetermined direction, and the at least one detecting device is located on the flattened surface to face the supporting structure portion or the caliper body.

27. The caliper and support assembly of claim 26, wherein the sensor cantilever portion extends along said predetermined direction.

28. A method for detecting a displacement of a caliper body relative to a supporting structure of a caliper and support assembly during a braking action, the method comprising:
connecting the caliper body to a first fixing portion of the supporting structure with a connecting portion of the supporting structure to allow the displacement of the caliper body along a predetermined direction;
constraining the caliper body to a second fixing portion of the supporting structure with a constraining element elastically deformable at least along said predetermined direction to allow the displacement of the caliper body during the braking action and to prevent the displacement of the caliper body in absence of the braking action;
detecting the displacement of the caliper body during the braking action directly, by
identifying a caliper body portion facing a supporting structure portion, the supporting structure portion being one of the first fixing portion, the second fixing portion and the connecting portion, and
measuring a distance between the caliper body portion and the supporting structure portion during the braking action, or indirectly, by
measuring a change in a length of the constraining element at least along said predetermined direction.
